(19) United States
(12) Patent Application Publication
(10) Pub. No.: US 2014/0289036 A1
(43) Pub. Date: Sep. 25, 2014

(54) Marketing Prediction, Analysis, and Optimization

(71) Applicant: Pearce Aurigemma, American Fork, UT (US)

(72) Inventor: Pearce Aurigemma, American Fork, UT (US)

(21) Appl. No.: 13/466,909

(22) Filed: May 8, 2012

Related U.S. Application Data
(60) Provisional application No. 61/613,861, filed on Mar. 21, 2012.

(51) Int. Cl. G06Q 30/02

(52) U.S. Cl. 705/14.42

(57) ABSTRACT

For a plurality of subscribers of network content, a first value per subscriber of may be determined. The determination may be based on conversion data associated with a first advertisement. The first value per subscriber may be compared with a value associated with a second advertisement. The effectiveness of the second advertisement may be evaluated based on the comparison.

### PRIORITY INFORMATION

This application claims benefit of priority of U.S. Provisional Application Ser. No. 61/613,861 entitled “Marketing Prediction, Analysis, and Optimization” filed Mar. 21, 2012, the content of which is incorporated by reference herein in its entirety.

### BACKGROUND

Goods and services providers often employ various forms of marketing to drive consumer demand for products and services. Marketing includes various techniques to expose to target audiences to brands, products, services, and so forth. For example, marketing often includes providing promotions (e.g., advertisements) to an audience to encourage them to purchase a product or service. In some instances, promotions are provided through media outlets, such as television, radio, and the internet via television commercials, radio commercials and webpage advertisements. In the context of websites, marketing may include advertisements for a website and products associated with that website to encourage persons to visit and/or use the website, purchase products and services offered via the website, and/or otherwise interact with the website.

Marketing promotions often require a large financial investment. A business may fund an advertisement campaign with the expectation that increases in revenue attributable to marketing promotions exceed the associated cost. A marketing campaign may be considered effective if it creates enough interest and/or revenue to offset the associated cost.

In the context of internet advertising, tracking user interaction with a website is known as “web analytics.” Web analytics is the measurement, collection, analysis and reporting of internet data for purposes of understanding and optimizing web usage. Web analytics provides information about the number of visitors to a website and the number of page views, as well as providing information about the behavior of users while they are viewing the site.

### SUMMARY

Methods and apparatus for evaluating, predicting, and analyzing network activity are disclosed. For a plurality of subscribers of network content, a first value per subscriber may be determined. The determination may be based on conversion data associated with a first advertisement. The first value per subscriber may be compared with a value associated with a second advertisement. The effectiveness of the second advertisement may be evaluated based on the comparison.

### BRIEF DESCRIPTION OF THE DRAWINGS

FIG. 1 illustrates an example network content analytics system configured to perform marketing prediction, analysis, and/or optimization, according to one or more other embodiments.

FIG. 2 illustrates a module that may implement marketing prediction, analysis, and/or optimization, according to some embodiments.

FIG. 3 is a flowchart that illustrates a method for marketing prediction, analysis, and/or optimization, according to some embodiments.

FIG. 4 is a flowchart that illustrates a method for determining a value of a subscriber of network content, according to some embodiments.

FIG. 5 illustrates an example block diagram of a system configured to implement marketing prediction, analysis, and/or optimization, according to some embodiments.

FIG. 6 illustrates an example computer system that may be used in some embodiments.

While the disclosure is described herein by way of example for several embodiments and illustrative drawings, those skilled in the art will recognize that the disclosure is not limited to the embodiments or drawings described. It should be understood, that the drawings and detailed description thereto are not intended to limit the disclosure to the particular form disclosed, but on the contrary, the intention is to cover all modifications, equivalents and alternatives falling within the spirit and scope of the present disclosure. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

“First,” “Second,” etc. As used herein, these terms are used as labels for nouns that they precede, and do not imply any type of ordering (e.g., spatial, temporal, logical, etc.). For example, for a network analytics processing module evaluating an effectiveness of an advertisement, the terms “first” and “second” advertisements can be used to refer to any two advertisements. In other words, the “first” and “second” advertisements are not limited to logical advertisements 0 and 1.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

### Introduction

This specification presents an illustrative network content analytics system, as well as an illustrative network analytics processing module that may implement one or more of the disclosed marketing prediction, analysis, and optimization techniques. The specification then discloses techniques for evaluating an effectiveness of an advertisement and for determining the value per subscriber of network content. Various examples and applications are disclosed. Some of these techniques may be implemented, for example, by a network analytics processing module or computer system.

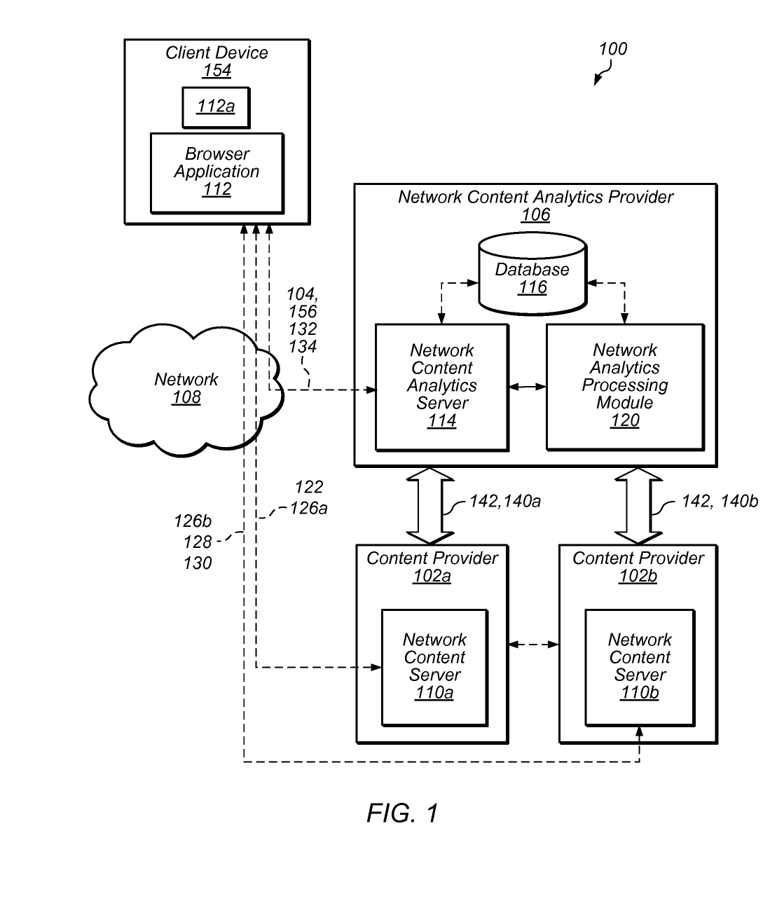

Some embodiments may include a means for marketing prediction, analysis, and optimization. For example, a network analytics processing module (e.g., network analytics processing module 120/220 of FIGS. 1/2) may determine the first value per subscriber based on conversion data, compare the first value per subscriber with a value associated with a second advertisement, and evaluate an effectiveness of the second advertisement, as described herein. The network analytics processing module may in some embodiments be implemented by a non-transitory, computer-readable storage medium and one or more processors (e.g., CPUs and/or GPUs) of a computing apparatus. The computer-readable storage medium may store program instructions executable by the one or more processors to cause the computing apparatus to perform determining the first value per subscriber based on conversion data, comparing the first value per subscriber with a value associated with a second advertisement, and evaluating an effectiveness of the second advertisement, as described herein. Other embodiments of the network analytics processing module may be at least partially implemented by hardware circuitry and/or firmware stored, for example, in a non-volatile memory.

In some embodiments, these techniques may be used in measuring the success of subscriber acquisition efforts, measuring the success of an advertisement campaign, or predicting marketing conversions, among other example applications. Although certain embodiments and applications are described in terms of marketing, it should be noted that the same or similar principles may be applied in other fields.

Although certain embodiments are described with respect to a webpage and/or website, it will be appreciated that the techniques disclosed herein may be employed with other forms of network content sites, such as documents with a traversable tree-like hierarchy (e.g., XML, HTML, etc.).

Turning now to the figures, FIG. 1 illustrates an example network content analytics system configured to support marketing prediction, analysis, and optimization, in accordance with one or more embodiments. Network content analytics system may be employed to accumulate and/or process analytics data 104 (e.g., conversion data, subscriber data, demographics data) representing various aspects of network activity used to assess an effectiveness of one or more items of network content. In the illustrated embodiment, system 100 includes content providers 102a and 102b (e.g., a social networking website and a company's website, respectively) hosting network content servers 110a and 110b, respectively, a client device 154 and a network content analytics provider 106.

Each of content providers 102a and 102b, client device 154 and network content analytics provider 106 may be communicatively coupled to one another via a network 108. Network 108 may include any channel for providing effective communication between each of the entities of system 100. In some embodiments, network 108 includes an electronic communication network, such as the internet, a local area network (LAN), a cellular communications network, or the like. Network 108 may include a single network or combination of networks that facilitate communication between each of the entities (e.g., content providers 102a and 102b, client device 154 and network content analytics provider 106) of system 100.

Client device 154 may retrieve content (e.g., a company affiliated fan page of a social networking website and/or a company website, respectively) from content providers 102a and/or 102b via network 108. Client device 154 may transmit corresponding analytics data 104 to network content analytics provider 106 via network 108. Network content analytics provider 106 may employ a network analytics processing module 120 to assess analytics data 104 and to perform determining the first value per subscriber based on conversion data, comparing the first value per subscriber with a value associated with a second advertisement, and evaluating an effectiveness of the second advertisement, as described herein.

While network analytics processing module 120 is shown in FIG. 1 as a component of network content analytics provider 106, one of skill in the art will readily realize in light of having read the present disclosure that network analytics processing module 120 may be embodied in a separate system with access to database 116 through network content analytics server 114 via network 108.

Content providers 102a and/or 102b may include the source of information/content (e.g., an HTML file defining display information for a webpage) that is provided to client device 154. For example, content provider 102a may be a social network website and content provider 102b may be a vendor website used to present retail merchandise to a consumer. In such an example, the social networking website may include a webpage that is a company affiliated fan page for that vendor/company. In some embodiments, content providers 102a and 102b may include respective network content servers 110a and 110b. Network content servers 110a and 110b may include web content 126a and 126b stored thereon, such as HTML files that are accessed and loaded by client device 154 for viewing webpages of content providers 102a and 102b. In some embodiments, content providers 102a and 102b may serve client device 154 directly. For example, content 126 may be provided from each of servers 110a or 110b directly to client device 154. In some embodiments, one of content providers 102a and 102b may act as a proxy for the other of content providers 102a and 102b. For example, server 110a may relay content from server 110b to client device 154. In one embodiment, content from content provider 102a may include a company affiliated page of a social network content site (e.g., fan/follower/subscriber page of twitter, Facebook, etc.). The company affiliated page of the social network content site may include a selectable element (e.g., a selectable link with an embedded code identifying an advertisement) that, when selected, redirects client device to content from content provider 102b.

Client device 154 may include a computer or similar device used to interact with content providers 102a and 102b. In some embodiments, client device 154 includes a wireless device used to access content 126a (e.g., web pages of a websites) from content providers 102a and 102b via network 108. For example, client device 154 may include a personal computer, a cellular phone, a personal digital assistant (PDA), or the like.

In some embodiments, client device 154 may include an application (e.g., internet web-browser application) 112 that can be used to generate a request for content, to render content, and/or to communicate request to various devices on the network. For example, upon selection of a website link on a webpage displayed to the user by browser application 112, browser application 112 may submit a request for the corresponding webpage/content to web content server 110b, and web content server 110b may provide corresponding content 126b, including an HTML file, that is executed by browser application 112 to render the requested website for display to the user. In some instances, execution of the HTML file may cause browser application 112 to generate additional request for additional content (e.g., an image referenced in the HTML file as discussed below) from a remote location, such as content providers 102a and 102b and/or network content analytics provider 106. The resulting webpage 112a may be viewed by a user via a video monitor or similar graphical presentation device of client device 154. While webpage 112a is discussed as an example of the network content available for use with the embodiments described herein, one of skill in the art will readily realize that other forms of content, such as audio or moving image video files, may be used without departing from the scope and content herein disclosed. Likewise, while references herein to HTML and the HTTP protocol are discussed as an example of the languages and protocols available for use with the embodiments described herein, one of skill in the art will readily realize that other forms of languages and protocols, such as XML or FTP may be used without departing from the scope and content herein disclosed.

Network analytics provider 106 may include a system for the collection and processing of analytics data 104, and the generation of corresponding metrics (e.g., hits, page views, visits, sessions, downloads, first visits, first sessions, visitors, unique visitors, unique users, repeat visitors, new visitors, impressions, singletons, bounce rates, exit percentages, visibility time, session duration, page view duration, time on page, active time, engagement time, page depth, page views per session, frequency, session per unique, click path, click, site overlay) and web analytics reports including various metrics of the web analytics data (e.g., a promotion effectiveness index and/or a promotion effectiveness ranking) Analytics data 104 may include data that describes usage and visitation patterns for websites and/or individual webpages within the website. Analytics data 104 may include information relating to the activity and interactions of one or more users with a given website or webpage. For example, analytics data 104 may include historic and/or current website browsing information for one or more website visitors, including, but not limited to identification of links selected, identification of web pages viewed, data regarding conversions (e.g., revenue from purchase/sale of an item, orders, bookings, leads, downloads), number of purchases, value of purchases, and other data that may help gauge user interactions with webpages/websites.

In some embodiments, analytics data 104 includes information indicative of a location. For example analytics data may include location data 108 indicative of a geographic location of client device 154. In some embodiments, location data 108 may be correlated with corresponding user activity. For example, a set of received analytics data 104 may include information regarding a user's interaction with a web page (e.g., activity data) and corresponding location data indicative of a location of client device 154 at the time of the activity. Thus, in some embodiments, analytics data 104 can be used to assess a user's activity and the corresponding location of the user during the activities. In some embodiments, location data includes geographic location information. For example, location data may include an indication of the geographic coordinates (e.g., latitude and longitude coordinates), IP address or the like or a user or a device. In some embodiments, analytics data may include demographic information indicate of the user.

In some embodiments, analytics data 104 is accumulated over time to generate a set of analytics data (e.g., an analytics dataset) that is representative of activity and interactions of one or more users with a given website or webpage. For example, an analytics dataset may include analytics data associated with conversions related to an advertisement, made by subscribers of network content. Analytics data may be processed to generate an evaluation of the effectiveness of the advertisement and, in some examples, continue, terminate, or otherwise modify the advertisement.

Network content analytics provider 106 may include a third-party website traffic statistic service. Network content analytics provider 106 may include an entity that is physically separate from content providers 102a and 102b. Network content analytics provider 106 may reside on a different network location from content providers 102a and 102b and/or client device 154. In the illustrated embodiment, for example, network content analytics provider 106 is communicatively coupled to client device 154 via network 108. Network content analytics provider 106 may be communicatively coupled to content providers 102a and 102b via network 108. Network content analytics provider 106 may receive analytics data 104 from client device 154 via network 108 and may provide corresponding analytics data (e.g., web analytics reports) to content provider 102a and 102b or to network analytics processing module 220 via network 108 or some other communication path.

In the illustrated embodiment, network content analytics provider 106 includes a network content analytics server 114, a network content analytics database 116, and a network content analytics processing module 120. In some embodiments, network analytics processing module 120 may include computer executable code (e.g., executable software modules) stored on a computer readable storage medium that is executable by a computer to provide associated processing. For example, network analytics processing module 120 may process web analytics datasets stored in database 116 to generate corresponding web analytics reports that are provided to content providers 102a and 102b. Accordingly, network analytics processing module 120 may assess analytics data 104 to determine an effectiveness of one or more promotions and perform the techniques described herein.

Network content analytics server 114 may service requests from one or more clients. For example, upon loading/rendering of a webpage 112a by browser 112 of client device 154, browser 112 may generate a request to network content analytics server 114 via network 108. Network content analytics server 114 may process the request and return appropriate content (e.g., an image) 156 to browser 112 of client device 154. In some embodiments, the request includes a request for an image, and network content analytics provider 106 simply returns a single transparent pixel for display by browser 112 of client device 154, thereby fulfilling the request. The request itself may also include web analytics data embedded therein. Some embodiments may include content provider 102a and/or 102b embedding or otherwise providing a pointer to a resource, known as a “web bug”, within the HTML code of the webpage 112a provided to client device 154. The resource may be invisible to a user, such as a transparent one-pixel image for display in a web page. The pointer may direct browser 112 of client device 154 to request the resource from network content analytics server 114. Network content analytics server 114 may record the request and any additional information associated with the request (e.g., the date and time, and/or identifying information that may be encoded in the resource request).

In some embodiments, an image request embedded in the HTML code of the webpage may include codes/strings that are indicative of web analytics data, such as data about a user/client, the user's computer, the content of the webpage, or any other web analytics data that is accessible and of interest. A request for an image may include, for example, “image.gif/XXX . . . ” wherein the string “XXX . . . ” is indicative of the analytics data 104. For example, the string “XXX” may include information regarding user interaction with a website (e.g., activity data).

Network content analytics provider 106 may parse the request (e.g., at network content analytics server 114 or network analytics processing module 120) to extract the web analytics data contained within the request. Analytics data 104 may be stored in database 116, or a similar storage/memory device, in association with other accumulated web analytics data. In some embodiments, network analytics processing module 120 may receive/retrieve analytics data from network content analytics server 114 and/or database 116. Network analytics processing module 120 may process the analytics data to generate one or more web analytics reports, including graphical displays and trend and prediction analysis, as described herein. For example, network content analytics server 114 may filter the raw web analytics data received at network content analytics server 114 to be used by network analytics processing module 120 in generating trends and predictions analytics reports, as may be requested by a website administrator of one of content providers 102a and 102b. Reports, for example, may include overviews and statistical analyses describing the relative frequency with which various site paths are being followed through the content provider's website, the rate of converting a website visit to a purchase (e.g., conversion), the value of a subscriber of network content, an effectiveness of various promotions, identifying trends in and making predictions from the data as requested, and so forth.

In some embodiments, client device 154 executes a software application, such as browser application 112, for accessing and displaying one or more webpages 112a. In response to a user command, such as clicking on a link or typing in a uniform resource locator (URL), browser application 112 may issue a webpage request 122 to web content server 110a of content provider 102a via network 108 (e.g., via the Internet). In response to request 122, web content server 110a may transmit the corresponding content 126a (e.g., webpage HTML code corresponding to webpage 112a) to browser application 112. Browser application 112 may interpret the received webpage code to display the requested webpage 112a at a user interface (e.g., monitor) of client 154. Browser application 112 may generate additional requests for content from the servers, or other remote network locations, as needed. For example, if webpage code calls for content, such as an advertisement, to be provided by content provider 102b, browser application 112 may issue an additional request 130 to web content server 110b. Web content server 110b may provide a corresponding response 128 containing requested content, thereby fulfilling the request. Browser application 112 may assemble the additional content for display within webpage 112a.

In some embodiments, client device 154 also transmits webpage visitation tracking information to web analytics provider 106. For example, as described above, webpage code may include executable code (e.g., a web bug) to initiate a request for data from network content analytics server 114 such that execution of webpage code at browser 112 causes browser 112 to generate a corresponding request (e.g., a web-beacon request) 132 for the data to web analytics server 114. In some embodiments, request 132 may itself have analytics data (e.g., analytics data 104) contained/embedded therein, or otherwise associated therewith, such that transmitting request 132 causes transmission of analytics data from client 154 to web analytics provider 106. For example, as described above, request 132 may include an image request having an embedded string of data therein. Network content analytics provider 106 may process (e.g., parse) request 132 to extract analytics data 104 contained in, or associated with, request 132.

In some embodiments, request 132 from client 154 may be forwarded from network content analytics server 114 to database 116 for storage and/or to network analytics processing module 120 for processing. Network analytics processing module 120 and/or network content analytics server 114 may process the received request to extract web analytics data 104 from request 132. Where request 132 includes a request for an image, network content analytics server 114 may simply return content/image 134 (e.g., a single transparent pixel) to browser 112, thereby fulfilling request 128. In some embodiments, network content analytics provider 106 may transmit analytics data (e.g., analytics data 104) and/or one or more corresponding analytics reports to content providers 102a and/or 102b, or other interested entities.

For example, analytics data and/or web analytics reports 140a and 140b (e.g., including processed web analytics data) may be forwarded to site administrators of content providers 102a and 102b via network 108, or other forms of communication. In some embodiments, a content provider may log-in to a website, or other network based application, hosted by network content analytics provider 106, and may interact with network analytics processing module 120 to generate custom web analytics reports. For example, content provider 102a may log into a web analytics website via website server 114, and may interactively submit request 142a to generate reports from network analytics processing module 120 for various metrics (e.g., number of conversions for male users that visit the home page of the content provider's website, an effectiveness of a promotion, etc.), and network analytics provider 106 may return corresponding reports (e.g., reports dynamically generated via corresponding queries for data stored in database 116 and processing of the network analytics processing module 120). In some embodiments, content providers 102a and 102b may provide analytics data to web analytics provider 106.

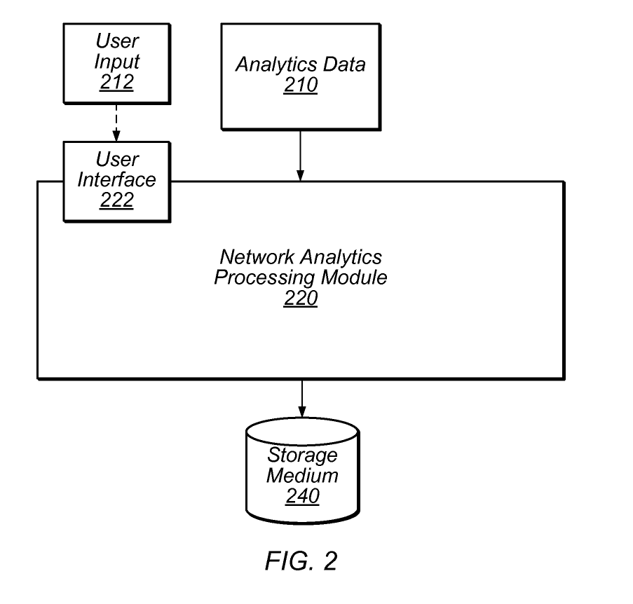

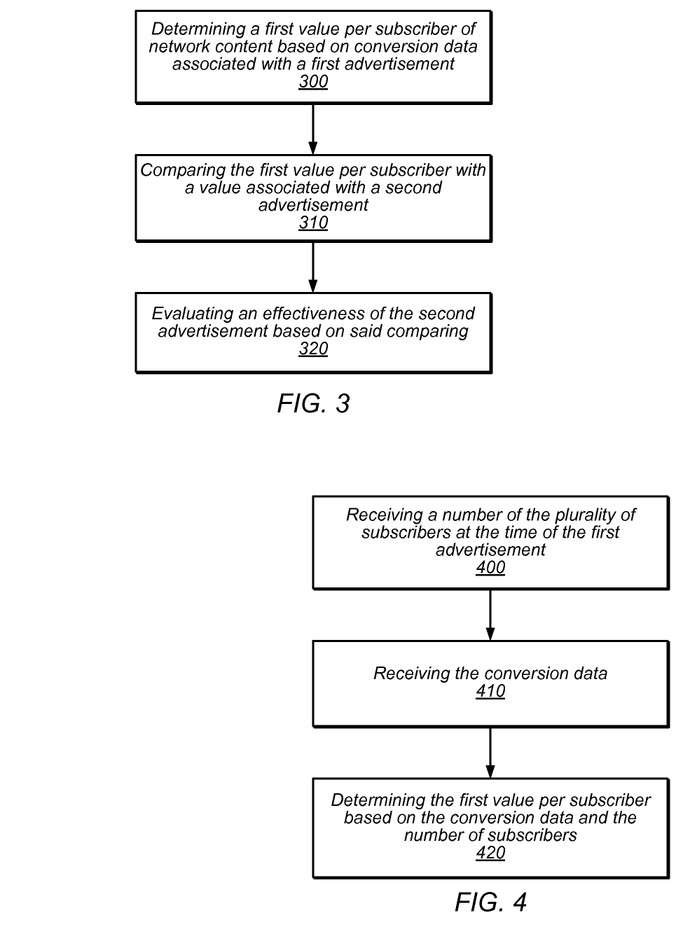

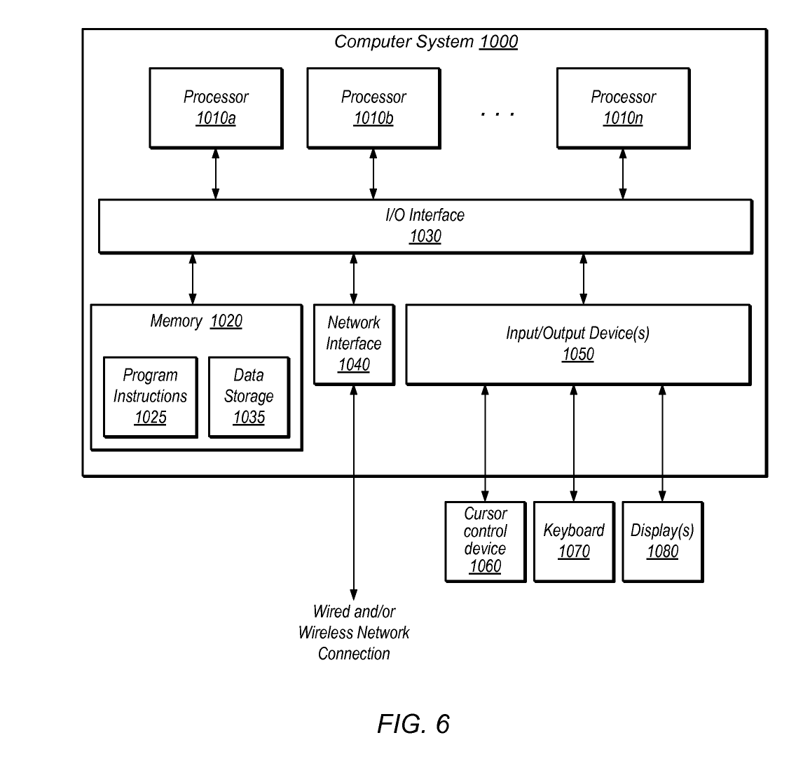

FIG. 2 depicts a module that may implement marketing prediction, analysis, and/or optimization, according to some embodiments. Network analytics processing module 220 (which may be the same module as network analytics processing module 120 of FIG. 1) may, for example, implement one or more of the techniques described herein at FIGS. 3-4. FIG. 6 illustrates an example computer system on which embodiments of network analytics processing module 220 may be implemented. Network analytics processing module 220 may receive, as input, analytics data 210, as discussed herein. In some embodiments, network analytics processing module 220 may also receive user input 112 (e.g., selection of a demographic to analyze, selection of a particular advertisement campaign to analyze, etc.). User input 112 may be provided via touchscreen, mouse, keyboard, or other suitable device. Network analytics processing module 220 may then perform the techniques described herein at FIGS. 3-4 on the analytics data 210 based on any user input 112 received via user interface 122. For example, network analytics processing module 220 may determine the first value per subscriber based on conversion data, compare the first value per subscriber with a value associated with a second advertisement, and evaluate an effectiveness of the second advertisement. Network analytics processing module 220 may generate, as output, the value per subscriber of network content and/or an effectiveness of an advertisement and/or a determination on continuing the advertisement. The output may be stored to a storage medium 240, such as system memory, a disk drive, DVD, CD, etc.

Turning now to FIG. 3, one embodiment of marketing prediction, analysis, and/or optimization is illustrated. While the blocks are shown in a particular order for ease of understanding, other orders may be used. In some embodiments, the method of FIG. 3 may include additional (or fewer) blocks than shown. Blocks 300-320 may be performed automatically or may receive user input. In one embodiment, network analytics processing module 220 may implement the method of FIG. 3.

As shown at 300, a first value per subscriber of network content may be determined. The determination may be based on conversion data associated with a first advertisement. As described herein, the network content (e.g., company affiliated social network page) may be configured to present the first advertisement within the network content. A selectable element of the first advertisement may be selectable to present other network content (e.g., a company website). Conversion data may be based on one or more conversions made from that other network content that result from selection of the selectable element. A subscriber of network content may be a follower or fan of the network content. For example, a person who enjoys the products of company A may be a fan of company A's Facebook page. Company A's Facebook page may have a number of fans, which may be referred to as subscribers. In such an example, Company A's Facebook fan page may be the network content and Company A's website may be the other network content.

In one embodiment, the selectable element of the first advertisement may be in the form of a link on the network content. The link may be embedded with a code that enables tracking of conversions that result from selection of the link. In one embodiment, the network content may be a company affiliated content page of a social networking content site (e.g., fan page on twitter, Facebook, etc.). In such an embodiment, company affiliated content page may be configured to present the first advertisement (e.g., a link advertising a 10% off special for the company's products). Accordingly, the first advertisement may be accessible by the plurality of subscribers. In some examples, the first advertisement may be made available only to subscribers. In other examples, the first advertisement may be made available to others as well but the subscribers may be alerted to the presence of the advertisement by tweet, email, text message, other type of message, etc. Selection of a link on the company affiliated social network page may direct a web browser to the other content (e.g., company's website). A user may browse the company's website and choose to purchase and/or download content. Such purchases and/or downloads may be the one or more conversions made from the other network content that result from selection of the selectable element. Example conversion data may include revenue (e.g., dollar amount of purchases), number of orders, number of items consumed/purchased/downloaded, bookings, leads, etc. Regardless of the type of conversion data, the first value per subscriber may be determined based on that conversion data.

Determining the first value per subscriber may be performed according to demographics of the plurality of subscribers. For example, the first value per subscriber may be a global first value per subscriber for all subscribers of the content, or it may be performed separately for individual demographics. If performed according to demographics, a first value per female subscriber, a first value per male subscriber, a first value per age 21-30 subscriber, a first value per married subscriber, among other examples, may be determined. Demographics may be received as part of the conversion process (e.g., entering billing/shipping information upon purchasing a product) or may be profile characteristics for the social networking site. In one embodiment, upon selecting the selectable link, a user may be prompted to grant the other network content permission to access (e.g., request and/or receive) the profile characteristics information. For example, if the user grants the other network content access to the profile characteristics information, the other network content may request and/or receive such information via an application programming interface (API) of the social network content site. Note that a user may generally grant permission for access to profile characteristics information such that the user may not be prompted each time a selectable link is selected.

In one embodiment, conversion data may be based on one or more conversions made over a predefined period of time. For instance, conversion data may include conversions made during the duration of the advertisement, for a portion of the advertisement (e.g., first 4 hours, first business day of the promotion, 3 days, etc.), or relative to some other indicator (e.g., total revenue goal achieved). Such conversion data may be compiled into a data set.

In some embodiments, determining the first value per subscriber may be based on previous conversion data associated with one or more previous advertisements. Many variables (time of year, time of day, discount percentage, discounted items, number of subscribers, etc.) may have an effect on the first value per subscriber. For example, one advertisement may have been available on the day after Thanksgiving whereas another may have been available on a Wednesday in July. Or, one may have offered 10% off all products whereas another may have offered 15% off select items. By factoring in previous conversion data associated with one or more previous advertisements, a more robust value per subscriber may be achieved. The determining at block 300 may alternatively or additionally include an offset to account for expected variations due to the time of year. For instance, a value per subscriber based on an after Thanksgiving sale may be weighted down to allow for better comparisons with sales made during lower sales activity time periods.

Additional details for one example technique for determining the first value per subscriber is described at FIG. 4.

At 310, the first value per subscriber may be compared with a value associated with a second advertisement. In some embodiments, the value associated with the second advertisement may be an acquisition cost of a new subscriber for the second advertisement. The acquisition cost of a new subscriber may be based on the cost of the second advertisement and the number of new subscribers acquired after the second advertisement is made available (e.g., presented as part of the network content). For instance, the second advertisement may cost $100,000 and bring in 1000 new subscribers during the running of the advertisement (e.g., presented as part of the network content, presented over a television, radio, internet, or other media campaign, etc.). The acquisition cost may be $100 per new subscriber. Therefore, in such an example, the value/cost associated with the second advertisement may be 100.

In other embodiments, the value associated with the second advertisement may be a second value per subscriber of the network content based on conversion data for the second advertisement. As was the case with the first value per subscriber, in one embodiment, the second value per subscriber may be determined according to the method of FIG. 4 and/or in similar manner to that described at block 300.

In one embodiment, comparing the first value per subscriber with the value associated with the second advertisement may include determining which value is larger (or smaller) or if the values are the same. Before comparing the two values, one or more of the first value or value associated with the second environment may be normalized. The comparison may result in a binary result: the value associated with the second advertisement is less than, greater than, or equal to the first value (e.g., the binary result may be a 0 if less than or equal to and a 1 if greater than). The comparison may also, in addition to or instead of, result in a value of the difference between the two values, percentage difference, etc.

Consider a scenario in which the first value per subscriber is 10 (e.g., representing $10) and the value associated with the second advertisement is 12. As an example, the comparison at block 310 may result in any one or more of the following results: the value associated with the second advertisement is greater than the first value (e.g., could be represented by a binary value 1), the difference between the two values is 2, or the value associated with the second advertisement is 20% greater than the first value, among other possible results.

As illustrated at 320, an effectiveness of the second advertisement may be evaluated based on the comparing of 310. Based on the effectiveness evaluation, it may be determined whether to continue the second advertisement. For instance, the second advertisement may be evaluated as very poor (e.g., not successful or too successful) and may be discontinued. The second advertisement may be evaluated such that the second advertisement may continue as planned, or may be extended, upon which the method of FIG. 3 may be repeated such that later evaluations of the effectiveness of the second advertisement may be made at later times.

Turning now to FIG. 4, one embodiment of determining a value of a subscriber of network content is illustrated. While the blocks are shown in a particular order for ease of understanding, other orders may be used. In some embodiments, the method of FIG. 4 may include additional (or fewer) blocks than shown. Blocks 400-420 may be performed automatically or may receive user input. The method of FIG. 4 may be used in conjunction with the method of FIG. 3. Accordingly, a combination of some or all of the blocks of FIGS. 3-4 may be used in some embodiments. In one embodiment, network analytics processing module 220 may implement the method of FIG. 4

As shown at 400, a number of subscribers of the plurality of subscribers may be received. The number of subscribers may be received from company data storage, directly from the social network content site, or from some other data store. The number of subscribers may be the number of subscribers at the time of the advertisement (e.g., first advertisement). In embodiments using demographic factors, the total number of subscribers may be received and filtered according to the target demographics or the target demographics may be requested and only the number of subscribers of the target demographics may be received.

At 410, the conversion data may be received. The conversion data may be received from company data storage, directly from the company website, or from some other data store. The conversion data may be based on one or more conversions that resulting from selection of the selectable element of the advertisement. For instance, the conversions may have used a tracking code from the first advertisement. Once again, if demographic factors are used, the conversion data may be limited to the conversion data from subscribers of a certain demographic or may include conversion data from all subscribers, which may be filtered by network analytics processing module 220 as part of the method of FIGS. 3 and/or 4.

As illustrated at 420, the first value per subscriber may be determined based on the conversion data and the number of subscribers. For example, using revenue as an example of conversion data and a demographic specific determination of the first value, consider a scenario in which the number of female subscribers at the time of the advertisement is 5000 and the revenue attributed to purchases by female subscribers using the link with the tracking code is $1,000,000. In such an example, the value per female subscriber may be $200.

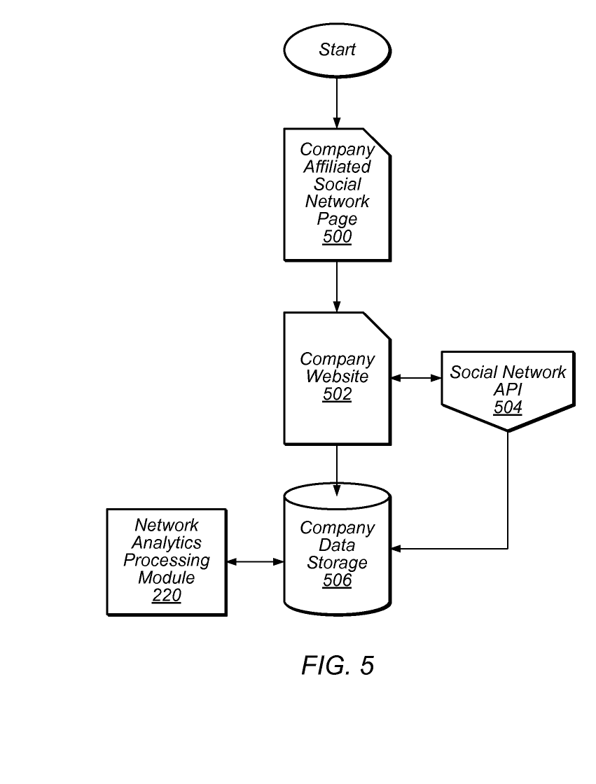

FIG. 5 illustrates an example block diagram of a system configured to implement marketing prediction, analysis, and/or optimization, according to some embodiments. An advertisement may be presented on company affiliated social network page 500 (e.g., a fan page of followers on twitter, Facebook, etc.). A subscriber/user may land on the fan page and click on a URL link for the advertisement, which is embedded with a tracking code. Selection of the link may direct the user to company web page 502. The user may land on company web page 502 and the tracking code may be stored (e.g., in company data storage 506). The user may traverse company website 502, which may actually include many individual webpages, and make a conversion (e.g., purchase an item, download content, etc.).

Company website 502 may be configured to communicate with social network API 504, and may be configured to receive various data from social network API 504. For example, a user may grant permission for company website 502 to obtain demographic information regarding the user from social network API 504. In response, company website 502 may retrieve the demographic data and provide it to company data storage 506. Company website 502 may also provide the conversion data to company data storage 506. Such conversion data may be linked/associated with the tracking code and the fan page link. Social network API 504 may provide the number of subscribers at the time the advertisement is presented on the fan page and a breakdown of those subscribers' demographics to company data storage 506. Company data storage 506 may store the data from company website 502 and social network API 504, and may be configured to provide that data to network analytics processing module 220. Network analytics processing module 220 may then implement at least some of the techniques described herein.

### Example System

Embodiments of a network analytics analysis module and/or of the various marketing prediction, analysis, and optimization techniques as described herein may be executed on one or more computer systems, which may interact with various other devices. One such computer system is illustrated by FIG. 6. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, one or more servers, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. In some embodiments, it is contemplated that embodiments may be implemented using a single instance of computer system 1000, while, in other embodiments, multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the techniques disclosed herein may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as the techniques described above are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 6, memory 1020 may include program instructions 1025, configured to implement embodiments of a network analytics analysis module as described herein, and data storage 1035, comprising various data accessible by program instructions 1025. In one embodiment, program instructions 1025 may include software elements of embodiments of a network analytics analysis module as illustrated in the above Figures. Data storage 1035 may include data that may be used in embodiments. In other embodiments, other or different software elements and data may be included.

Those skilled in the art will appreciate that computer system 1000 is merely illustrative and is not intended to limit the scope of a network analytics analysis module as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present disclosure may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the disclosure embrace all such modifications and changes and, accordingly, the above description to be regarded in an illustrative rather than a restrictive sense.

What is claimed is:

1. A computer-implemented method, comprising:
for a plurality of subscribers of network content, determining a first value per subscriber, wherein said determining is based on conversion data associated with a first advertisement;
comparing the first value per subscriber with a value associated with a second advertisement; and
evaluating an effectiveness of the second advertisement based on said comparing.

2. The method of claim 1, wherein the value associated with the second advertisement is an acquisition cost of a new subscriber for the second advertisement.

3. The method of claim 2, wherein the acquisition cost of a new subscriber for the second advertisement is based on a cost of the second advertisement and a number of new subscribers acquired after the second advertisement is made available.

4. The method of claim 1, wherein the value associated with the second advertisement is a second value per subscriber of the network content based on other conversion data for the second advertisement.

5. The method of claim 1, wherein said determining the first value per subscriber includes:
receiving a number of the plurality of subscribers of the network content at the time of the first advertisement;
receiving the conversion data, wherein the conversion data is based on one or more conversions that used a tracking code of the first advertisement; and
determining the first value per subscriber based on the received conversion data and the received number of the plurality of subscribers.

6. The method of claim 1, wherein the network content is configured to present the first advertisement within the network content, wherein a selectable element of the first advertisement is selectable to present other network content, and wherein the conversion data is based on one or more conversions made from the other network content that result from selection of the selectable element.

7. The method of claim 1, wherein the network content is a company affiliated content page of a social networking content site, wherein the company affiliated content page is configured to present the first advertisement, wherein the first advertisement is accessible by the plurality of subscribers.

8. The method of claim 7, wherein the first advertisement includes a selectable element that is selectable to present a company content site, wherein the conversion data is based on one or more conversions made on the company content site that result from selection of the selectable element.

9. The method of claim 1, wherein said determining the first value per subscriber is performed according to demographics of the plurality of subscribers.

10. The method of claim 1, wherein the conversion data is based on one or more conversions made over a predefined period of time.

11. The method of claim 1, wherein said determining the first value per subscriber is further based on previous conversion data associated with one or more previous advertisements.

12. The method of claim 1, further comprising determining whether to continue the second advertisement based on said evaluating.

13. A non-transitory computer-readable storage medium storing program instructions, wherein the program instructions are computer-executable to implement:
for a plurality of subscribers of network content, determining a first value per subscriber, wherein said determining is based on conversion data associated with a first advertisement;
comparing the first value per subscriber with a value associated with a second advertisement; and
evaluating an effectiveness of the second advertisement based on said comparing.

14. The non-transitory computer-readable storage medium of claim 13, wherein said determining the first value per subscriber includes:
receiving a number of the plurality of subscribers of the network content at the time of the first advertisement;
receiving the conversion data, wherein the conversion data is based on one or more conversions that used a tracking code of the first advertisement; and
determining the first value per subscriber based on the received conversion data and the received number of the plurality of subscribers.

15. The non-transitory computer-readable storage medium of claim 13, wherein the network content is a company affiliated content page of a social networking content site, wherein the company affiliated content page is configured to present the first advertisement, wherein the first advertisement is accessible by the plurality of subscribers.

16. The non-transitory computer-readable storage medium of claim 15, wherein the first advertisement includes a selectable element that is selectable to present a company content site, wherein the conversion data is based on one or more conversions made on the company content site that result from selection of the selectable element.

17. A system, comprising:
at least one processor; and
a memory comprising program instructions, wherein the program instructions are executable by the at least one processor to:
for a plurality of subscribers of network content, determine a first value per subscriber, wherein said determining is based on conversion data associated with a first advertisement;
compare the first value per subscriber with a value associated with a second advertisement; and
evaluate an effectiveness of the second advertisement based on said comparing.

18. The system of claim 17, wherein to perform said determining the first value per subscriber, the program instructions are further executable by the at least one processor to:
receive a number of the plurality of subscribers of the network content at the time of the first advertisement;
receive the conversion data, wherein the conversion data is based on one or more conversions that used a tracking code of the first advertisement; and
determine the first value per subscriber based on the received conversion data and the received number of the plurality of subscribers.

19. The system of claim 17, wherein the network content is a company affiliated content page of a social networking content site, wherein the company affiliated content page is configured to present the first advertisement, wherein the first advertisement is accessible by the plurality of subscribers.

20. The system of claim 19, wherein the first advertisement includes a selectable element that is selectable to present a company content site, wherein the conversion data is based on one or more conversions made on the company content site that result from selection of the selectable element.
